(19) United States
(12) Patent Application Publication
(10) Pub. No.: US 2026/0274215 A1
(43) Pub. Date: Sep. 17, 2026

(54) TRAILER SLED

(71) Applicant: BDR LABS, Inc., Denver, CO (US)

(72) Inventors: Peter James, Denver, CO (US); Gary Seminara, Golden, CO (US); Floyd Henning, Arvada, CO (US); William Klarquist, Littleton, CO (US)

(21) Appl. No.: 19/563,497

(22) Filed: Mar. 11, 2026

Related U.S. Application Data
(60) Provisional application No. 63/770,041, filed on Mar. 11, 2025.

(51) Int. Cl. B60S 13/00; B60K 1/00; B60K 17/04; G05D 1/667; G05D 107/10

(52) U.S. Cl. CPC B60S 13/00; B60K 1/00; B60K 17/04; G05D 1/667; G05D 2107/10

(57) ABSTRACT

An automated trailer sled for moving semi-trailers within a yard without active human supervision. The trailer sled comprises a propulsion unit and a rear bogie connected via a linkage mechanism. The propulsion unit engages with and lifts the front of a trailer. The rear bogie travels underneath the trailer to the rear tires and lifts them using lift units comprising front and rear arms that compress against the tires. The rear bogie may include powered rollers, a scissor-jack mechanism, or a pivoting arm to assist with the lift.

### CROSS-REFERENCE TO RELATED APPLICATIONS

This application claims the benefit of and priority to U.S. Provisional Patent Application No. 63/770,041, filed Mar. 11, 2025, the entire contents of which are incorporated herein by reference for all purposes.

### FIELD

The present disclosure relates to automated machines for moving trailers within a yard or other facility. More particularly, embodiments relate to an automated trailer sled comprising a propulsion unit and a powered rear bogie configured to lift and transport semi-trailers without active human supervision.

### BACKGROUND

The movement of goods and materials often involves the use of semi-trucks and trailers. The trailers are often loaded with goods and materials at loading docks or yards. These trailers are large and difficult to move and maneuver around yards or other locations. Frequently, these trailers need to be moved within a yard to make space for other trailers, to move the trailer to a loading dock, and to move the trailer to be positioned for connection to a semi-truck for delivery. A typical trailer move cycle is to move the trailer from a parking spot to a loading dock, and then back to a parking spot. A number of different approaches are used to maneuver these trailers within a yard or other location.

One approach is to use a traditional semi-truck to move trailers within a yard. These trucks have fixed 5th wheels, requiring the driver to get out of the cab to manually raise and lower trailer landing gear. This limits their efficiency in high-throughput trailer yards. They also must connect air lines to the trailer to release emergency brakes and connect service brakes. To operate safely at night, they must connect an electrical line to the trailer to operate lights. When backing trailers, they leave a blind spot behind the trailer, causing a safety issue that results in deaths and injuries. These trucks also require specialized, trained operators who are difficult to hire and retain.

Manual yard trucks are an improvement over on-road semi-trucks. They have a 5th wheel that can raise and lower, removing the need for the driver to manually raise and lower trailer landing gear. This improves their efficiency, making them the tool of choice for nearly every high-throughput trailer yard. However, the driver must still connect air and electrical lines, somewhat limiting efficiency. Like on-road semi-trucks, yard trucks leave a blind spot behind the trailer when backing, creating a safety issue. They also have the same operator staffing issues.

Another approach is to use autonomous yard trucks. Autonomous yard trucks utilize computing and sensing resources added to a manual yard truck. They are an attempt to address the driver staffing issues of manual yard trucks. However, they still have the blind spot safety issue, and they must address the complex air and electrical line connections. Today’s approaches attempt to use a robotic arm or a specialized trailer modification. The robotic arm is complex, fragile, and costly. Modifying trailers could make business sense for a captive trailer fleet, but it doesn’t work for yards that service third-party trailers. Finally, these systems are still in development and not yet commercially viable at any scale.

Trailer dollies are used at low-throughput yards where only a handful of trailers need to be moved infrequently. They do not require a specialized operator, but they do leave the other challenges in place, and they are impractical for high-throughput yards due to their low speeds.

Some companies make robots that resemble cabless yard trucks. They can be remotely controlled or automated to move trailers around private property. However, a human must still connect air and electrical lines. This reduces the specialization required for operators, but it also limits throughput as a human must be present each time a trailer is connected or disconnected. The backing blind spot issue is still present as well.

It would be desirable to provide an automated machine that allows safe and efficient movement of trailers within a yard. It would further be desirable to provide such an automated machine that can be operated without active human supervision.

### BRIEF DESCRIPTION OF THE DRAWINGS

Illustrative embodiments may take form in various components and arrangements of components. Illustrative embodiments are shown in the accompanying drawings, throughout which like reference numerals may indicate corresponding or similar parts in the various drawings. The drawings are only for purposes of illustrating the embodiments and are not to be construed as limiting the disclosure. Given the following enabling description of the drawings, the novel aspects of the present disclosure should become evident to a person of ordinary skill in the relevant art(s).

FIGS. 1A-1C are perspective views of a trailer sled pursuant to some embodiments.

FIGS. 2A-2D are views of a rear bogie lift unit of a trailer sled pursuant to some embodiments.

FIGS. 3A-3C are views of operation of a trailer sled in conjunction with a trailer pursuant to some embodiments.

FIG. 4 is a block diagram of a functional control architecture of a trailer sled pursuant to some embodiments.

FIG. 5A is a perspective view of a rear bogie showing a roller lift mechanism in a deployed configuration pursuant to some embodiments.

FIGS. 5B and 5C are a top view and a front view, respectively, of a rear bogie showing a roller lift mechanism in a deployed configuration pursuant to some embodiments.

FIGS. 5D and 5E are a perspective view and a front view, respectively, of a rear bogie in a collapsed configuration pursuant to some embodiments.

FIG. 5F is a detail view of a powered roller mechanism for a lift arm pursuant to some embodiments.

FIG. 5G is a detail view of a scissor-jack lift mechanism for a lift arm pursuant to some embodiments.

FIGS. 5H and 5I are detail views showing a pivoting arm lift mechanism in a lowered position and a raised position, respectively, engaging with a trailer tire pursuant to some embodiments.

FIGS. 5J and 5K are perspective views of a lift arm showing a powered roller configuration and a scissor-jack configuration, respectively, pursuant to some embodiments.

FIG. 5L is a perspective view of a lift arm showing a pivoting arm configuration pursuant to some embodiments.

FIG. 6 is a plan view of an example trailer yard showing operational paths of a trailer sled pursuant to some embodiments.

FIG. 7 is a schematic view of the trailer sled illustrating sensor placement and fields of view pursuant to some embodiments.

FIG. 8 is a flow diagram depicting a process pursuant to some embodiments.

### DETAILED DESCRIPTION

While the illustrative embodiments are described herein for particular applications, it should be understood that the present disclosure is not limited thereto. Those skilled in the art and with access to the teachings provided herein will recognize additional applications, modifications, and embodiments within the scope thereof and additional fields in which the present disclosure would be of significant utility.

### Physical Structure of the Trailer Sled

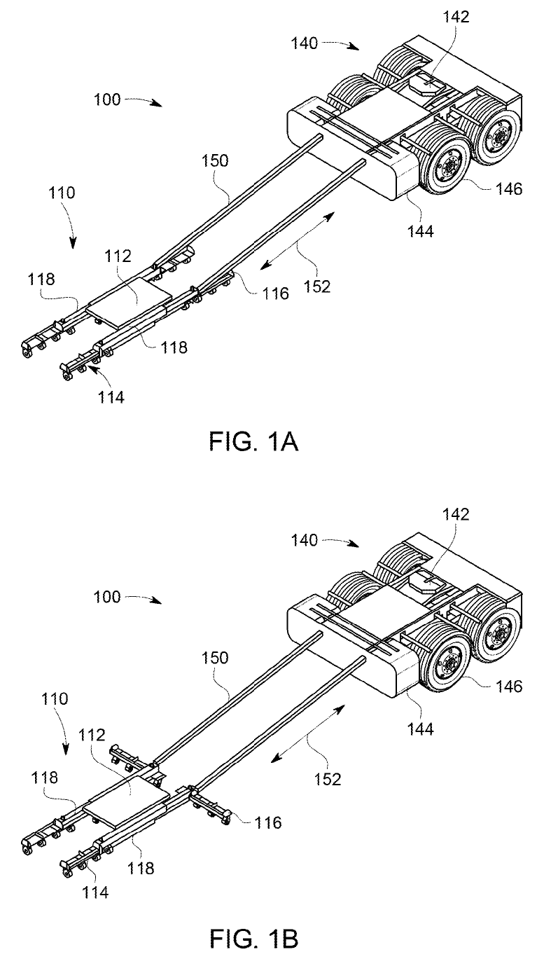

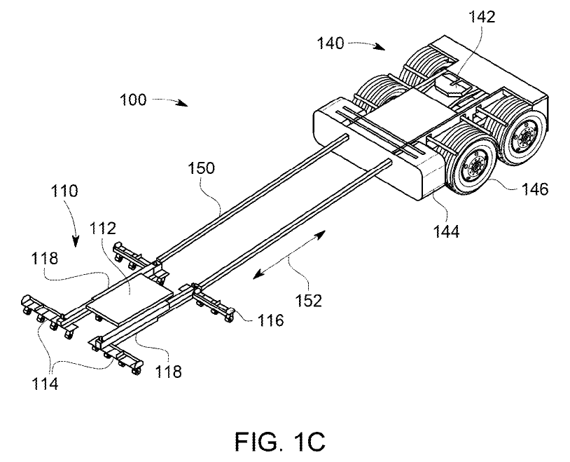

Embodiments provide an automated machine (referred to herein as a “trailer sled”) that is intended to replace today’s yard trucks. It is designed to fit underneath semi-trailers of varying lengths and configurations, pick them up so that their landing gear and wheels are off of the ground, and move the trailers to a specific location within the confines of a facility (such as a private facility or a yard, warehouse trailer lot, port, intermodal rail yard or the like, for ease, generally referred to herein as a “yard” or “facility”) all without active human supervision. Features of some embodiments will now be described by first referring to FIG. 1.

FIG. 1A depicts a perspective view of a trailer sled 100 pursuant to some embodiments. The trailer sled 100 comprises two main parts: a propulsion unit 140 and a rear bogie 110. The propulsion unit 140 is connected to the rear bogie 110 via a linkage mechanism 150. In the embodiment depicted in FIG. 1A, the linkage mechanism 150 consists of two rods or conduits that extend from the propulsion unit 140 to the rear bogie 110 and which, for example, carry electrical cables allowing operation of the rear bogie 110. In some embodiments, the rear bogie 110 has an independent drive mechanism allowing autonomous movement of the rear bogie 110 as described herein. In some embodiments, the linkage mechanism 150 may be or include a mechanism to allow the propulsion unit 140 to control, move, or otherwise manipulate the rear bogie 110. For example, the linkage mechanism 150 may be a wireless interface between the propulsion unit 140 and the rear bogie 110. As another example, the linkage mechanism 150 may be a physical connection between the propulsion unit 140 and the rear bogie 110 such that operation of the propulsion unit 140 may cause movement of the rear bogie 110.

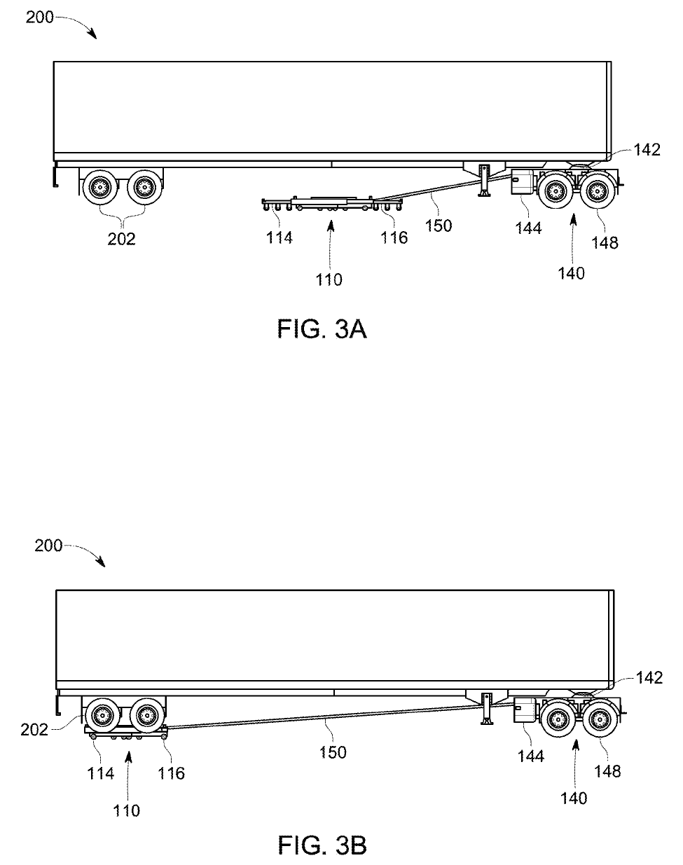

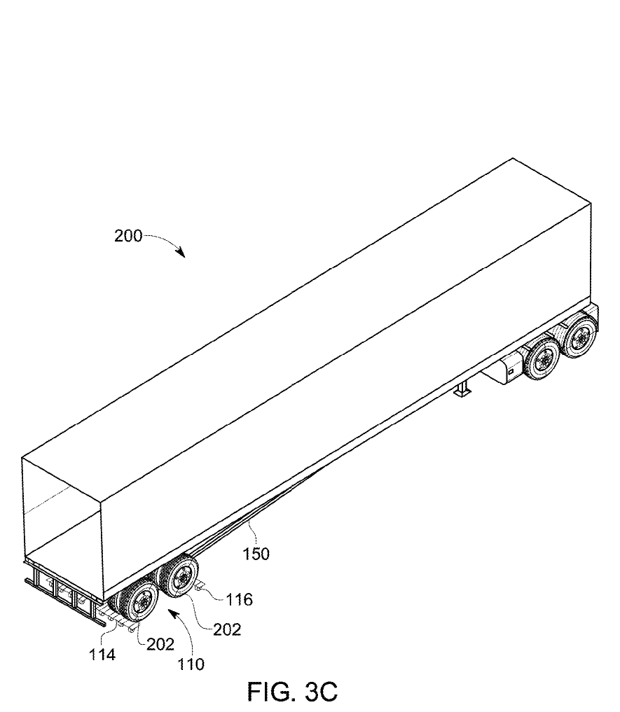

As will be described herein, the rear bogie 110 is extended to position the rear bogie 110 proximate rear tires of a trailer (not shown in FIG. 1A but shown in FIG. 3 below) to lift the trailer for movement within a yard. The propulsion unit 140 includes a mechanism to engage with a kingpin of a trailer. For example, in some embodiments, the mechanism may be a moveable fifth wheel 142 which may be positioned to mate with a kingpin on the underside of a trailer to be moved. Other mechanisms may also be used (for example, a cylinder that engages with the kingpin on the underside of a trailer, etc.). The propulsion unit 140 also includes tires 146 which allow the propulsion unit 140 to be moved within a yard and also to support and move a trailer when coupled to a trailer. The propulsion unit 140 is an item of yard machinery that may be operated to lift the front of a trailer without requiring trailer modification or pneumatic or electrical connections with the trailer. It has a power generation unit (such as a diesel engine, battery pack, fuel cell, or hybrid power system), traction (such as a mechanical drivetrain, e-axle, or individual drive motors), steering, braking, and other parts typical of a truck minus the driver controls, cabin, and interfaces.

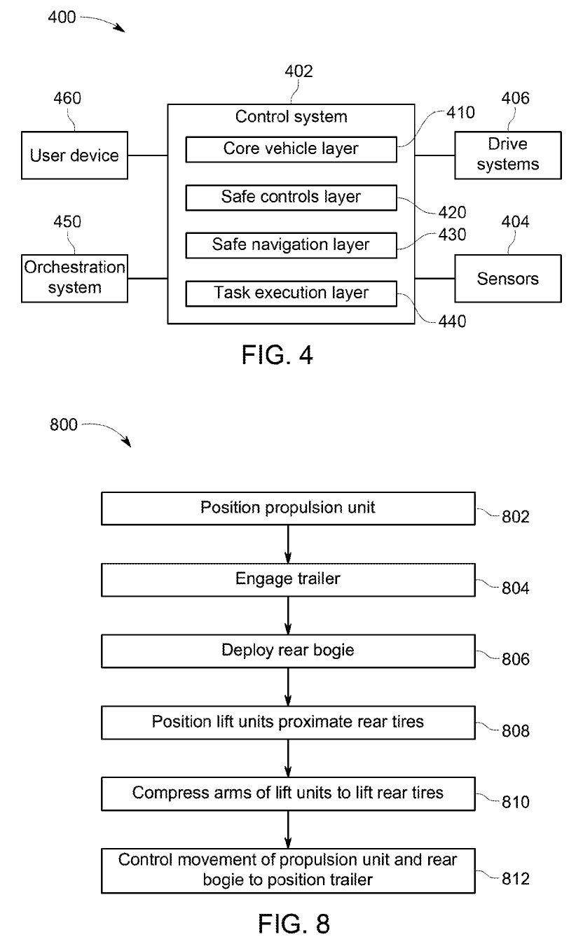

The propulsion unit 140 carries control systems 144 (including, for example, computing systems, power sources, drive systems, and control devices) to cause the autonomous movement of the trailer sled 100 within a yard as well as to control the movement, positioning, and operation of the rear bogie 110 as described herein. In some embodiments, the control systems of the propulsion unit 140 (including those shown in FIG. 4) operate in conjunction with control systems that are deployed on the rear bogie 110. In general, the control systems of the propulsion unit 140 oversees the control systems deployed on the rear bogie 110 (e.g., such that the control systems of the rear bogie 110 are configured to perform low-level control operations of the rear bogie 110 such as deploying lift arms as described further herein). Pursuant to some embodiments, both the propulsion unit 140 and the rear bogie 110 have onboard sensing and computing resources to enable safe automated operation. Sensors may include LIDAR, cameras, RADARs, GPS or other location or localization sensors, pressure sensors, time-of-flight cameras, ultrasonic sensors or the like. Lighting is also provided on both units to avoid needing to use the trailer lights at night.

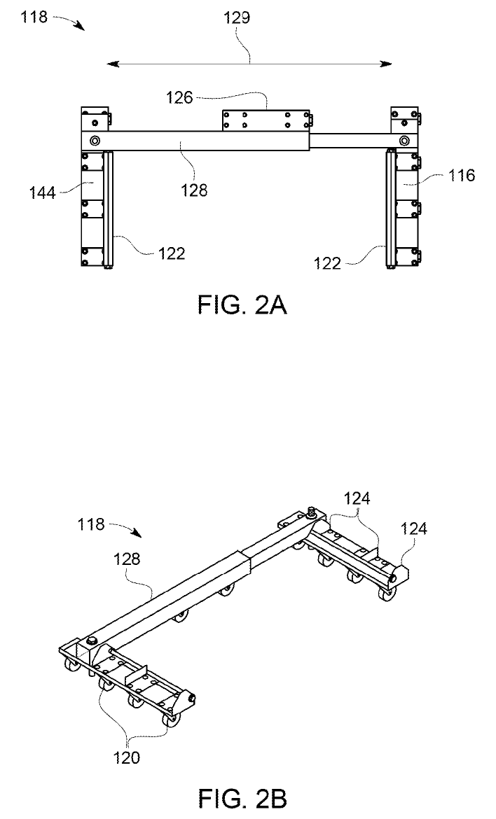

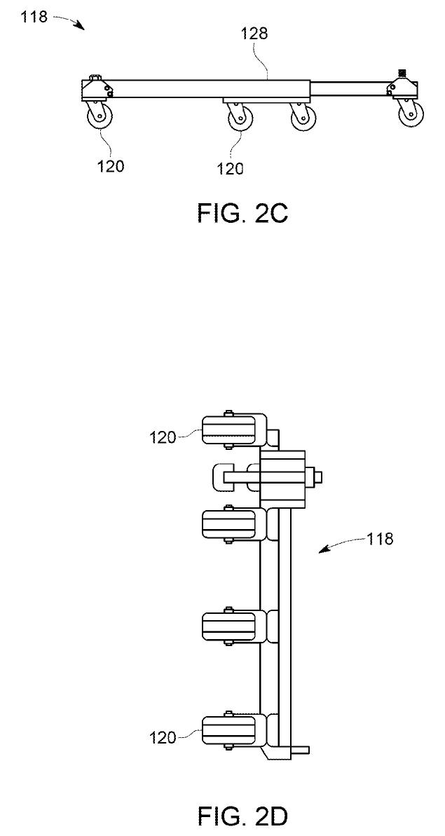

The rear bogie 110 includes two lift units 118 and a central drive unit 112. Each lift unit 118 includes a rear arm 114 and a front arm 116. The rear bogie 110 (which may also be referred to herein as a powered bogie) has a central drive unit 112 that enables the rear bogie 110 to move from the propulsion unit 140 (in some embodiments, under battery power) to the rear of a trailer. It also has two lift mechanisms, right and left, which may be, for example, substantially mirrors of each other (as will be described further below in conjunction with FIG. 2). The central drive unit 112 (in communication with the control systems 144) causes movement of the rear arms 114 and front arms 116 such that they are positioned proximate the rear tires of a trailer so that the trailer can be lifted off the ground and moved under control of the trailer sled 100.

In the position shown in FIG. 1A, the rear bogie 110 is in a first configuration in which the rear arms 114 and the front arms 116 are parallel to the linkage mechanism 150, allowing the rear bogie 110 to be moved underneath a trailer until the rear bogie 110 is proximate the rear tires of the trailer. A view of this first configuration with a trailer 200 is shown in FIG. 3A. In FIG. 3A, the propulsion unit 140 has been maneuvered such that it is coupled to a kingpin of the trailer 200 at 142. The propulsion unit 140, in this position, is able to support the front of the trailer 200, and the rear bogie 110 is moved rearward (toward the rear tires 202 of the trailer 200) by operation of the rear bogie 110 (e.g., by operation of drive wheels in the rear bogie 110).

Referring now to FIG. 1B, the rear bogie 110 is shown in a second configuration in which the front arms 116 are positioned perpendicular to the rear arms 114, allowing the front arms 116 to be moved rearward (by operation of a drive system of the rear bogie 110) to be positioned proximate the rear tires 202 of the trailer 200. Once the rear bogie 110 is proximate the rear tires 202, the rear arms 114 are positioned to be perpendicular to the rear tires 202 (and substantially parallel to the front arms 116). This forms a u-shape configuration of the arms 114, 116 which engage with the tires 202. This position is shown in FIG. 1C. The lift unit 118 and the arms 114, 116 are then controlled (as will be described further below), to lift the rear tires 202 allowing the trailer sled 100 to move the trailer 200.

A perspective view of the positioning of the propulsion unit 140 and the rear bogie 110 under a trailer 200 is shown in FIGS. 3A-3C. In FIGS. 3A-3C, the propulsion unit 140 is shown as coupled to the underside of the trailer 200 at the front wheels 148 at a moveable fifth wheel 142 (and a kingpin). The propulsion unit 140 is coupled and positioned to take the weight of the front part of the trailer 200 and, when operated, to lift the front wheels 148 from the ground so the propulsion unit 140 can maneuver the trailer 200 (once the rear bogie 110 has been deployed to lift the rear wheels 202). In FIG. 3A, the rear bogie 110 is shown as being deployed away from the propulsion unit 140 towards the rear wheels 202 of the trailer 200. In the embodiment shown, the rear bogie 110 is coupled to the propulsion unit 140 via a linkage mechanism 150. In other embodiments, the linkage mechanism 150 may be a wireless communication interface between the propulsion unit 140 and the rear bogie 110. In FIG. 3A, the arms 114, 116 are positioned generally parallel with the direction of travel (towards the rear wheels 202). In FIG. 3B, the rear bogie 110 has been maneuvered proximate the rear wheels 202 and the lift arms 114, 116 have been moved into a position perpendicular to the length of the trailer 200 (e.g., to form a u-shape, with one arm 114 of a lift unit behind the right rear wheels 202 another arm 114 of the lift unit behind the left rear wheels, one arm 116 of a lift unit in front of the right rear wheels 202 and another arm 116 of the lift unit in front of the left wheels 202). This position is shown in a different view in FIG. 3C. When in this u-shaped orientation, the lift unit can be operated as discussed below to bring the arms 114, 116 towards each other, coming into contact with the rear wheels and lifting them onto the arms 114, 116 so that the trailer 200 may be moved and positioned using the trailer sled 100 as described herein.

### Lift Unit Mechanisms

Features of the lift unit 118 of the rear bogie 110 will now be described by reference to FIG. 2. As shown in FIG. 2A, the lift unit 118 includes a front arm 116 and a rear arm 114 attached to a lift unit slide arm 128. The lift unit slide arm 128 is movable (to extend or retract as shown by arrow 129) to place the front arms 116 and rear arms 114 nearer or further from each other. When the rear bogie 110 is positioned proximate the rear tires 202 of a trailer 200, the lift unit slide arm 128 retracts to bring the rear arms 114 and front arms 116 in close contact with the rear tires 202 and lift them. The lifting is assisted by a cylinder 122 on each arm 114, 116 with a surface that allows the rear tires 202 to climb onto the arms 114, 116. The cylinder 122 may be formed as other shapes or configurations which allow the rear tires 202 to readily climb onto the arms 114, 116. In some embodiments, the cylinder 122 may rotate to further encourage the rear tires 202 to climb onto the arms 114, 116. Once the rear tires 202 are on top of the arms 114, 116, a number of lift unit wheels 120 allow movement of the rear bogie 110 and the trailer 200. Pursuant to some embodiments, movement of the lift unit slide arm 128 is controlled by the central drive unit 112 operating a piston 126. When a trailer 200 has been moved into a desired position in the yard, the sequence of events described above is repeated in reverse order (e.g., the lift unit slide arm 128 is expanded to release the tires 202, the rear arm 114 is positioned such that it is removed from the rear tires 202, etc.).

Pursuant to some embodiments, the entire rear bogie 110, including each lift unit 118, is designed to maintain a low profile of approximately 12 inches (about 30.5 cm) or less in overall height. This height constraint is driven by the need to pass beneath the trailer undercarriage without contacting brake canisters, axle hardware, suspension components, or other items mounted to the underside of the trailer. In various trailer configurations surveyed, approximately 12 inches was identified as a minimum clearance threshold below which trailer undercarriage components are generally not encountered, particularly in the region of the rear axles. This low-profile design constraint informs the design of the lift mechanisms described herein.

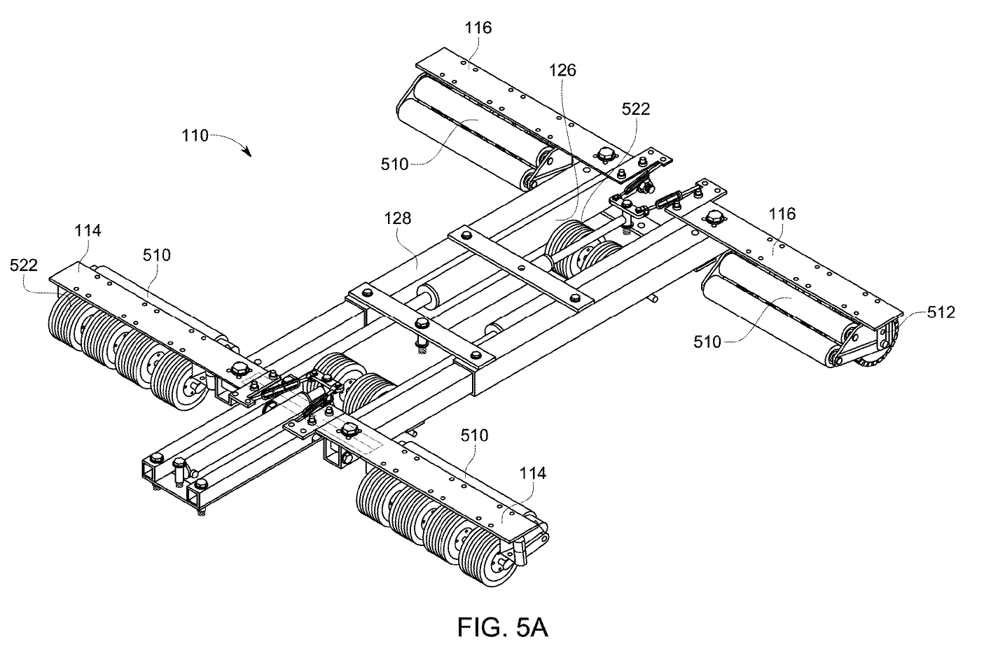

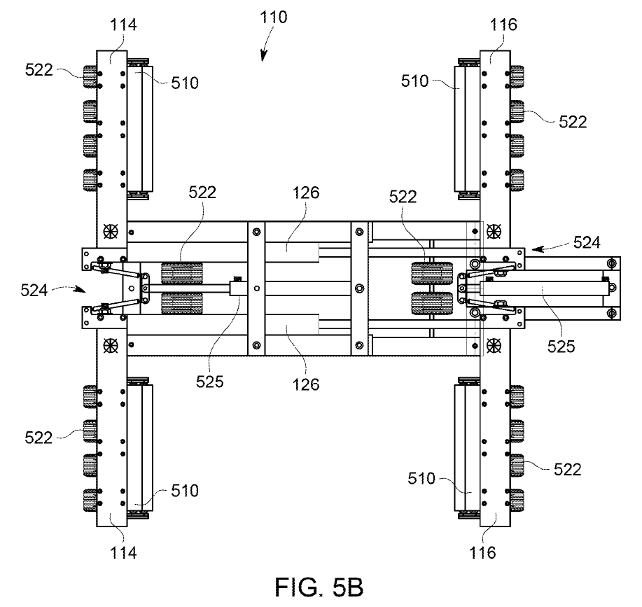

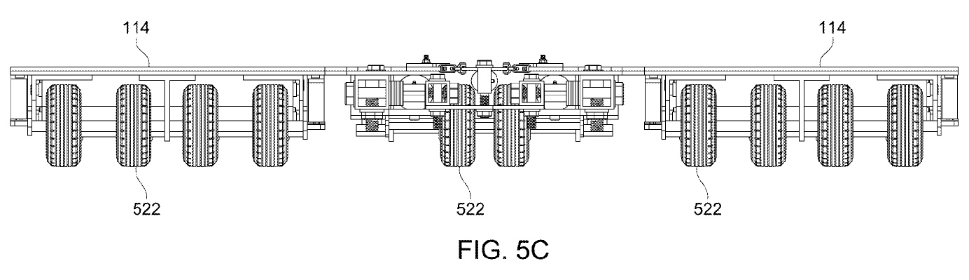

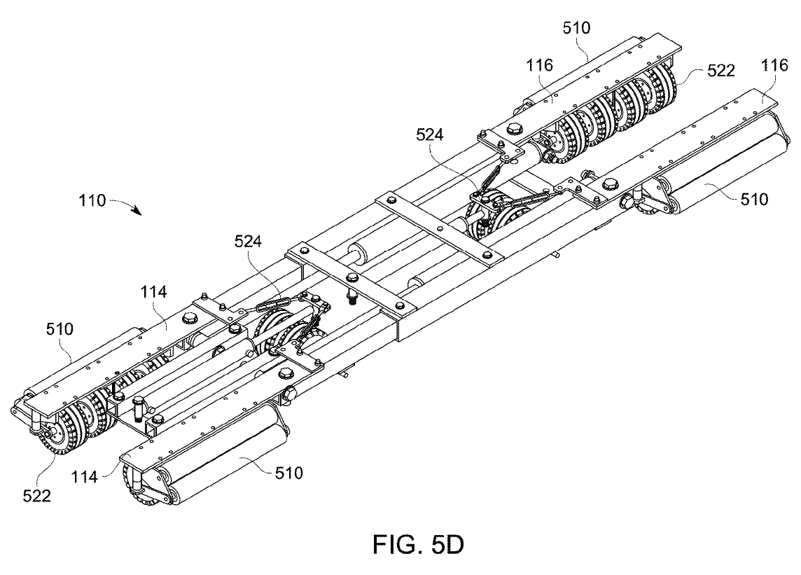

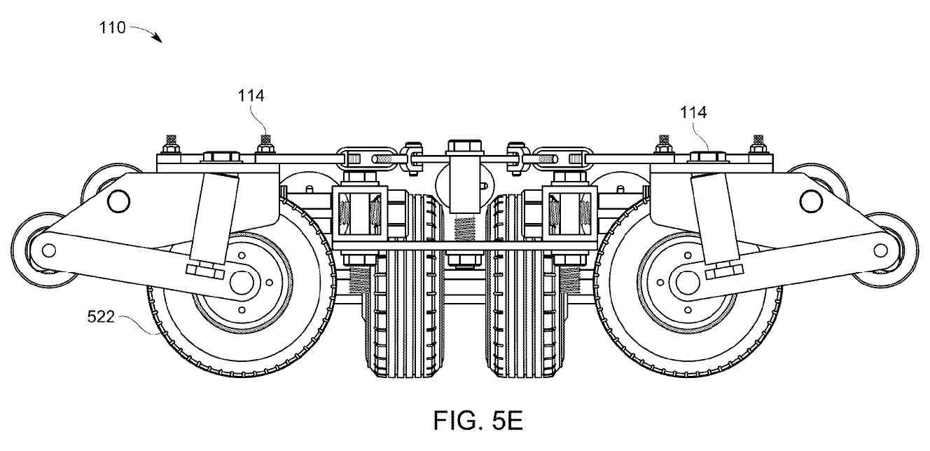

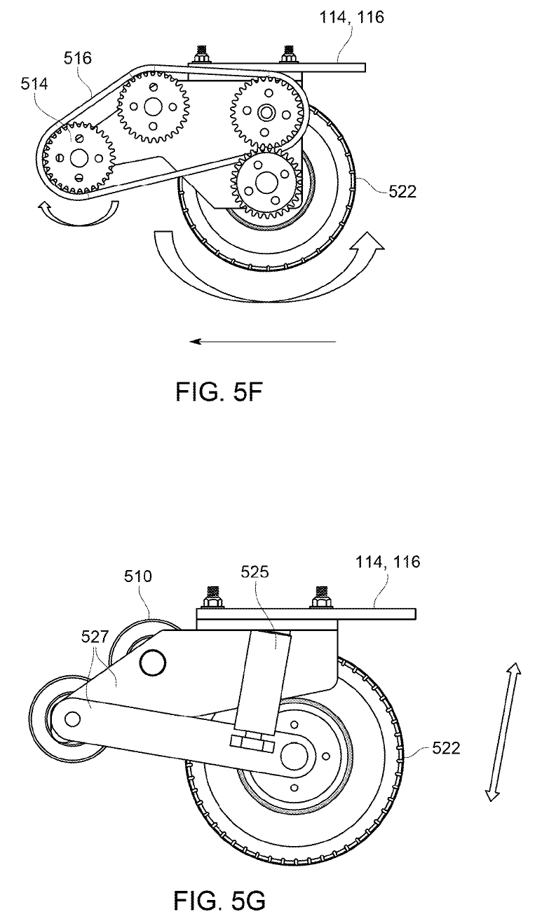

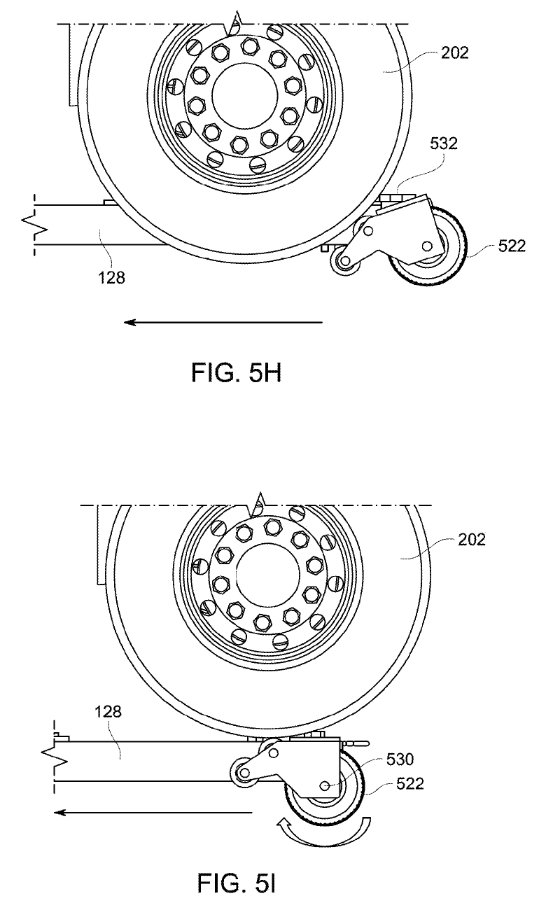

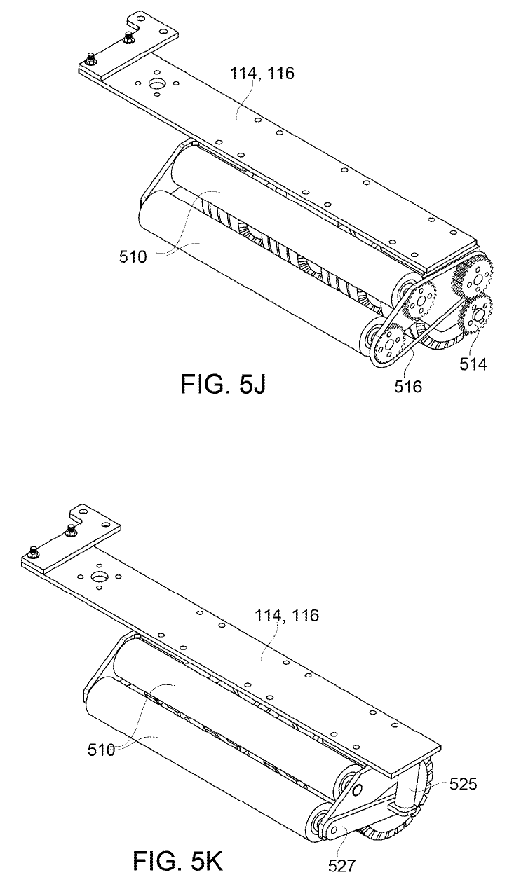

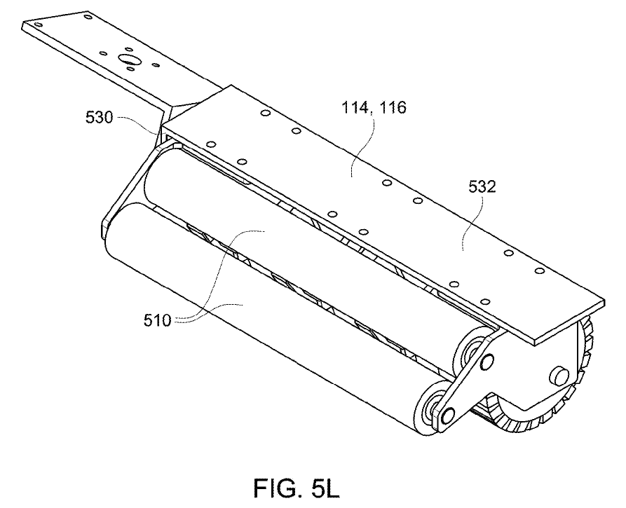

Referring now to FIG. 5A, an alternative lift mechanism embodiment is shown in which the arms 114, 116 of the rear bogie 110 include one or more rollers 510 (which may be powered rollers as shown in FIG. 5F or unpowered rollers). The rollers 510 are rotatably mounted to the arms 114, 116 and are configured to actively assist the trailer tires 202 in climbing onto the arms 114, 116 during the lift sequence. In operation, as the lift unit slide arm 128 retracts to bring the arms 114, 116 into contact with the tires 202, the rollers 510 rotate in a direction that draws the tires 202 upward and onto the arm surfaces. This reduces the compressive force required from the piston 126 to lift the trailer rear, thereby reducing mechanical stress on the lift unit 118 and extending component life.

Referring now to FIG. 5B, a top view of the lift mechanism embodiment of FIG. 5A is shown, and shows that the arms 114, 116 have a flat top surface onto which tires 202 may be rolled (assisted by the rotation of the rollers 510). FIG. 5B also depicts the use of multiple rear bogie wheels 522 which allow movement of the rear bogie 110 as described herein. FIG. 5B also depicts the two linkage mechanisms 524 which enables the arms 114, 116 to be deployed from an unextended position (as shown in FIG. 5D) to an extended position (as shown in FIG. 5B). In some embodiments (as shown in FIG. 5), the linkage mechanisms 524 are each driven by a hydraulic actuator 525. Ends of each linkage mechanism 524 are connected to an arm 114 or arm 116. When the hydraulic actuator 525 moves it pushes or pulls the center of the linkage mechanism 524 causing the arms 114, 116 to expand outwardly or collapse inwardly (depending on the action of the hydraulic actuator 525). This allows the rear bogie 110 to be positioned in either a narrow (or collapsed) configuration (as shown in FIG. 5D and FIG. 5E) or in a extended position (as shown in FIG. 5B). For example, under control of the control system 400 (and/or control electronics of the rear bogie 110), the rear bogie 110 may be placed in a collapsed configuration (as shown in FIG. 5D and FIG. 5E) and moved beneath a trailer 200. Once the rear bogie 110 is in position underneath the trailer 200 (e.g., proximate the rear tires 202 of the trailer 200), the control system 400 may cause the hydraulic actuator 525 to push the center of the linkage mechanism 524 to cause the arms 114, 116 to expand outwardly. The control system 400 may then operate to cause the lift unit slide arm 128 to retract to bring the arms 114, 116 into contact with the tires 202. Once the trailer 200 has been moved by the trailer sled 100 to a desired location, the reverse operation may be performed (to expand the arms 114, 116 to bring them out of contact with the tires 202 and to cause the hydraulic actuator 525 to pull the center of the linkage mechanism 524 to cause the arms 114, 116 to retract into a position allowing the rear bogie 110 to be withdrawn from underneath the trailer 200).

While a hydraulic actuator 525 is shown in operation with a linkage mechanism 524, other embodiments may be used to expand or retract the arms 114, 116. For example, the linkage mechanism 524 may be or include a scissor linkage, a four-bar linkage, a telescoping actuator, a cam mechanism, a sliding rail system, a rack-and-pinion system, a cable-driven mechanism, or any device capable of converting longitudinal actuator motion into lateral arm deployment. Further, the rollers 510 may be configured in a number of different ways. For example, the rollers 510 may be or include cylindrical rollers (as shown in FIG. 5). The rollers 510 may also be tapered (at one or both ends) to assist in the positioning of the tires 202. The rollers 510 may be compliant, segmented, or covered with friction material, belt surfaces or continuous tracks. Further, some or all of the rollers 510 may be powered, passive, magnetically driven, mechanically driven, friction-coupled, or the like.

Referring now to FIG. 5D and FIG. 5E, the rear bogie 110 is shown in a collapsed configuration. The rear bogie 110 may be placed in this collapsed configuration while the rear bogie 110 is being extended beneath a trailer to ensure the arms 114, 116 do not contact any part of the undercarriage of the trailer (such as landing gear legs or trailer tires). Once placed in position proximate the rear tires of the trailer, the arms 114, 116 can be extended as described herein. The rear bogie 110 is collapsed by operation of the mechanism 524.

In some embodiments, such as shown in, FIGS. 5F and 5J the rollers 510 are powered rollers 510 driven by a motor 512, such as an electric motor or a hydraulic motor, mounted within or adjacent to the arm 114, 116. The motor (not shown) may be independently controlled by the central drive unit 112 or by a local controller on the rear bogie 110. In some embodiments, the powered rollers 510 are mechanically driven by rotation of the trailer tires 202 themselves. For example, as the arms 114, 116 compress against the outer radius of the tires 202 and the tires 202 begin to rotate due to the compressive force, a gear train 514 or belt and chain drive 516 mechanically couples the tire rotation to the powered rollers 510, causing the rollers 510 to rotate in a direction that lifts the tires 202 onto the arms 114, 116. In some embodiments, the powered rollers 510 may be a combination of motorized and mechanically driven rollers.

Referring now to FIG. 5G and FIG. 5K, another alternative lift mechanism embodiment is shown in which the arms 114, 116 include a two-stage lift apparatus. In this embodiment, the lift sequence comprises a first stage and a second stage. In the first stage, the lift unit slide arm 128 retracts to bring the arms 114, 116 into contact with the tires 202 (not shown in FIGS. 5G or 5K), similar to the embodiment of FIG. 2. The arms 114, 116 are configured with passive rollers or wheels that slide beneath the tires 202 at the low-profile height of approximately 12 inches or less. In the second stage, once the arms 114, 116 are positioned beneath the tires 202, a scissor-jack mechanism 527 (or equivalent vertical lift mechanism, such as a hydraulic piston 525 on a scissor linkage) is actuated to raise the arms 114, 116 and thereby lift the tires 202 off the ground. The scissor-jack mechanism 527 may provide approximately 3 to 4 inches (about 7.6 to 10.2 cm) of vertical travel. This two-stage approach separates the lateral engagement force from the vertical lifting force, reducing the total compressive force required in the first stage and reducing mechanical stress on the system.

In some embodiments, the scissor-jack mechanism 527 is actuated by a hydraulic piston 525 operated by a hydraulic power unit in the rear bogie 110. The hydraulic piston 525 applies force to a scissor linkage 527 comprising two pairs of crossed arms connected by pivot joints, such that extension of the piston 525 causes the scissor linkage 527 to expand vertically, raising the arm surface upon which the tires 202 rest. In some embodiments, the vertical lift mechanism may be a linear actuator, a pneumatic cylinder, a screw jack, or other mechanism capable of providing the required vertical displacement under load.

Referring now to FIG. 5H , FIG. 5I and FIG. 5L yet another alternative lift mechanism embodiment is shown in which the arms 114, 116 include a pivot joint 530. The pivot joint 530 allows the arm to rotate between a lowered position (FIG. 5H) and a raised position (FIG. 5I). In the lowered position, the arm presents a low profile that enables it to slide beneath the trailer tires 202 during lateral engagement. As the lift unit slide arm 128 retracts and the tires 202 are compressed against the arms 114, 116, the tires 202 roll onto the arm surface 532. As the tire 202 moves past a center point of the arm, the weight of the tire 202 causes the arm to pivot about the pivot joint 530, mechanically generating an upward lifting motion. This over-center mechanism converts the lateral compressive force into a vertical lifting force without requiring a separate actuator for the vertical lift.

In some embodiments, a wheel stop (not shown) or other mechanical limit is provided on the arm to prevent the tire 202 from overshooting the arm surface during the pivot motion. Wheel stops or other mechanical limits may be used with any (or all) of the embodiments of lift arms described herein. In some embodiments, a biasing element (such as a spring or damper, not shown) may be provided at the pivot joint 530 to control the rate and force of the pivoting motion. In some embodiments, the pivoting arm mechanism may be combined with powered rollers 510 (as described in connection with FIG. 5A) to further assist the lifting process.

### Functional Control Architecture

Referring now to FIG. 4, the trailer sled 100 is controlled by an electronic control architecture 400 comprising a control system 402, sensors 404, and drive systems 406 distributed across the propulsion unit 140 and the rear bogie 110. Pursuant to some embodiments, the control system 402 is organized into four functional layers: a core vehicle layer 410, a safe controls layer 420, a safe navigation layer 430, and a task execution layer 440. Both the propulsion unit 140 and the rear bogie 110 implement all four architecture layers, enabling each unit to operate with a degree of autonomy while coordinating with the other unit.

The core vehicle layer 410 is the lowest layer and is responsible for fundamental vehicle functions including steering, braking, throttle control, power management, and instrumentation. The core vehicle layer 410 receives low-level control commands from the safe controls layer 420 and translates them into electronic signals, messages, or other commands to actuators and vehicle subsystems.

The safe controls layer 420 is responsible for safely controlling the core vehicle layer 410 via speed and steering control loops, state estimation, and stability monitoring. The safe controls layer 420 receives speed and steering requests from the safe navigation layer 430 and executes closed-loop control to achieve the requested speed and steering while monitoring vehicle state and enforcing safety limits.

The safe navigation layer 430 is responsible for following a given path (such as a series of waypoints, a spline, or other trajectory representation) by issuing speed and steering control requests to the safe controls layer 420 based on the estimated pose (position and orientation) of the trailer sled 100. In some embodiments, the safe navigation layer 430 uses Model Predictive Control (MPC) to generate safe speed and steering commands that keep the trailer sled 100 on a desired trajectory within stability constraints while avoiding obstacles. The safe navigation layer 430 also detects obstacles along the path and avoids colliding with them through speed and/or steering adjustments, including stopping, path deviation, or both.

The task execution layer 440 is the highest layer. It receives task-level orders (such as: move trailer X from location Y to destination Z) from a yard-level orchestration system 450, such as a Yard Management System (YMS), creates an execution plan, and is responsible for carrying out that plan. This includes generating a path or set of paths through the operating environment and requesting the safe navigation layer 430 to execute them. The task execution layer 440 also builds and maintains a model of the surrounding environment based on sensor inputs to support path planning around other objects and in accordance with any yard-level traffic rules. In some embodiments, the task execution layer 440 localizes the trailer sled 100 relative to a stored reference site model in real-time and dynamically updates a current local model to adapt to the current site configuration. The task execution layer 440 then dynamically plans safe vehicle trajectories leveraging local yard rules, prior knowledge of the site road and lane network, and learned paths based on prior task executions and operator input. The system 400 may also include one or more user devices 460 which may be configured to interact with the control system 402 (e.g., to view status, modify settings, and otherwise interface with the control system 402).

The automated control architecture 400 may be implemented using one or more computing devices, including, for example, one or more central processing units (“CPUs”) or graphic processing units (“GPUs”). The automated control architecture 400 may store computer program code that is executable by the CPUs or GPUs to perform processing as described herein. The automated control architecture 400 may exchange information with other devices (including, for example, communication between the trailer sled 110 and the propulsion unit 140, as well as communication with one or more remote user devices 460 and orchestration systems 450) via any communication network or protocol, including, for example: a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

### Sensing and Perception

Referring now to FIG. 7, the trailer sled 100 includes a sensor suite distributed across both the propulsion unit 140 and the rear bogie 110. The propulsion unit 140 includes one or more forward-facing sensors 710 (such as LIDAR, cameras, RADAR, and/or ultrasonic sensors) for detecting obstacles, yard infrastructure, and trailers ahead of the propulsion unit 140. The propulsion unit 140 may also include lateral sensors 712 and rearward-facing sensors 714. The rear bogie 110 includes sensors 720 directed toward the undercarriage of the trailer. The rear bogie 110 also includes rearward-facing sensors 722 for detecting the trailer rear tires 202, axles, brake canisters, suspension components, and other undercarriage elements, as well as for sensing loading dock infrastructure, obstacles behind the trailer and parking spot boundaries. Forward-facing sensors 724 on the rear bogie 110 may be positioned andtowards the front of the trailer 200 for detecting landing gear and the propulsion unit 140 after dropping off a trailer 200 and moving the rear bogie 110 back towards the propulsion unit 140.

Pursuant to some embodiments, the trailer sled 100 uses the sensor suite to detect and identify trailers. To confirm that a trailer is present in a parking spot or loading dock, the Task execution layer 440 interrogates a world model (maintained based on sensor data) to determine the presence of a trailer when the trailer sled 100 is close enough to the spot to ensure adequate sensor coverage. Presence of a trailer (rather than another object) is confirmed using specific trailer features, such as landing gear, the general shape of a trailer profile, and knowledge of the trailer type (if available). In some embodiments, the trailer sled 100 uses classical geometric registration techniques, such as Iterative Closest Point (ICP), and compact learned trailer model representations, such as 3D Gaussian Splatting (3DGS), to detect, identify, and localize the trailer sled pose relative to the trailer.

In some embodiments, the trailer sled 100 is configured to automatically identify trailers by their trailer identification number and/or Standard Carrier Alpha Code (SCAC). Cameras onboard the trailer sled 100 capture an image of the front of the target trailer, and the trailer sled 100 detects and extracts the trailer ID and SCAC using optical character recognition (OCR) or text extraction techniques. Specific methods may include traditional OCR methods, convolutional neural networks (CNNs) trained on a database of trailer IDs expected to be present at a given site, or other machine learning approaches. In some embodiments, the trailer sled 100 reads trailer IDs and SCACs opportunistically while driving around the yard. Images are correlated to specific parking spots and loading docks based on the trailer sled pose and the pose of the camera relative to the trailer sled (as part of calibration data). Each trailer ID is captured along with its location in an inventory database for future use by the yard management system or the trailer sled’s own Task execution layer 440.

The rear bogie 110 uses its onboard sensors to navigate under the trailer and detect trailer components. When the rear bogie 110 is deployed toward the rear of the trailer, it uses sensors (such as LIDAR, monocular vision, stereo vision, structured light, or combinations thereof) to detect the trailer landing gear and plan a path between the landing gear legs while verifying there is sufficient clearance. The bogie pose relative to the landing gear legs is estimated using fusion of onboard sensor data and prior knowledge of standard trailer configurations. In some embodiments, traditional 3D point cloud processing and voxel-level detection and registration techniques are used to register sensor data to the landing gear geometry and estimate minimum clearance for safe maneuver. In the primary embodiment, the rear bogie 110 approaches the rear tires 202 from the front of the trailer, passing between the landing gear legs and traveling rearward under the trailer until it reaches the rear tires 202.

In the wireless rear bogie embodiment (in which the rear bogie 110 is completely detached from the propulsion unit 140 and operates wirelessly), the rear bogie 110 may approach the trailer 200 from the side or other directions. For example, the rear bogie may approach the trailer 200 by entering between the landing gear and the rear tires 202 from a lateral direction. This lateral approach is particularly useful for rail yard trackside operations where trailers are parked alongside rail tracks and the front of the trailer is not accessible for a front-to-rear approach. The wireless rear bogie 110 embodiment may approach from almost any direction (e.g., front-to-rear, rear-to-front, lateral side entry, via a diagonal path, from the rail-side in a rail yard, etc.).

Upon reaching the rear tires 202, the rear bogie 110 uses its onboard sensors to detect the rear tires 202 and axles, estimate the clearance below the axles and between the tires, and plan a path to position itself for engaging the lift point. Detection and localization of the rear bogie pose with respect to the rear trailer undercarriage is performed using robust model fitting techniques, such as Random Sample Consensus (RANSAC) or Iterative Closest Point (ICP), applied to fused onboard 2D and 3D sensor data. In some embodiments, the sensor data is fitted against a learned prior model of undercarriage components including tires, axles, brake canisters, and suspension elements to determine optimal lift engagement positioning.

In some embodiments, the rear bogie 110 monitors the rear lift process via onboard sensors that monitor a combination of tire height, bogie lift mechanism position, and lift mechanism force measurements (such as hydraulic pressure or motor torque). When the tires 202 are confirmed to be fully off the ground (for example, by observing that the measured force drops after reaching a peak, indicating the trailer weight has transferred to the lift unit 118, or by perceiving via camera or LIDAR that the tires 202 are no longer in contact with the ground surface), the lift process is considered complete and the trailer sled 100 may proceed to transit.

### Operation of the Trailer Sled

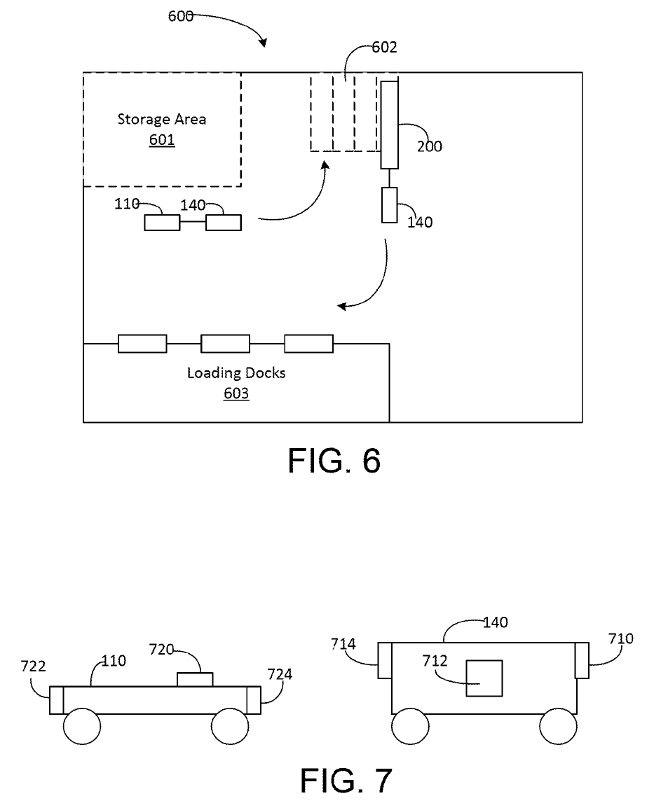

Operation of the trailer sled 100 will now be described with reference to FIG. 6, which depicts a plan view of an example trailer yard. The trailer yard 600 includes a storage area 601, parking spots 602, and loading docks 603. The trailer sled 100 may perform a number of different tasks during an operating period, as described below.

At the beginning of an operating shift, the trailer sled 100 resides in the storage area 601 where it waits for operations to begin. Operations are initiated via an API command from the yard-level orchestration software, typically a customer-provided Yard Management System (YMS). Upon reception of the command, the trailer sled 100 exits a low-power mode and performs stationary startup checks. Startup checks may include verifying proper software versions, up-to-date yard maps, sensor calibrations, and safety system integrity. In some embodiments, safety systems may be verified before movement begins.

Once stationary checks are complete, the trailer sled 100 drives out of the storage area 601. Final self-tests are performed during initial movement, such as verifying localization estimates against the stored site model and performing in-motion safety proof checks, such as verifying brake performance by measuring deceleration response.

After leaving the storage area 601, the trailer sled 100 drives through the yard without a trailer toward a first pickup location. The trailer sled 100 obeys yard rules during transit, including rules regarding: staying under speed limits, following lane and route directionality, stopping at intersections, and respecting traffic precedence.

During traversal, the task execution layer 440 localizes the trailer sled pose relative to the reference (stored) site model in real-time and dynamically updates its current local model to adapt to the current site configuration. The task execution layer 440 dynamically plans vehicle trajectories leveraging local yard rules, prior knowledge of the site road and lane network, and learned paths based on prior task executions and operator input. Those paths are sent to the safe navigation layer 430, which uses Model Predictive Control (MPC) to generate speed and steering commands to keep the trailer sled 100 on a desired trajectory within stability constraints and avoiding obstacles. Those commands are passed to the safe controls layer 420, which executes the speed and steering control loops by issuing low-level controls (messages, electronic signals, etc.) to the core vehicle layer 410 and monitoring vehicle state.

Upon reaching a specified parking spot, the trailer sled 100 confirms that a trailer is actually in the spot and that the correct trailer is in the spot, as described above in connection with the sensing and perception capabilities. In some embodiments, confirmation of the correct trailer is performed with remote assistance via a video feed from the trailer sled 100. Ideally, the customer provides the remote assistance if they do not trust their yard inventory. In some embodiments, automatic confirmation by the trailer sled 100 is performed as described above.

After confirming the correct trailer is in the parking spot, the trailer sled 100 stages near the trailer in preparation for picking it up. In most cases, the staging location is directly in front of the trailer. At rail yards, when picking up from a trackside parking spot, the staging location may be in front of and beside the trailer.

When staging in front of the trailer, the trailer sled 100 aligns to the trailer and drives toward the front of the trailer. When the propulsion unit 140 is near or partially underneath the trailer front, the propulsion unit 140 deploys the rear bogie 110 to allow it to navigate to the rear of the trailer. The rear bogie 110 uses onboard sensors to detect the trailer landing gear and plan a path between the landing gear legs while verifying there is sufficient clearance, as described above. Referring to FIG. 3A, once the rear bogie 110 is deployed from the propulsion unit 140, the propulsion unit 140 maneuvers to securely engage with the front of the trailer and lift it. Lifting can occur from any load bearing point, including the king pin, frame rails, or other structural members of the trailer front. During the deployment process, the control system 400 performs obstacle detection processing. If, for example, an obstacle is under the trailer 200, the deployment may be halted and an operator alerted.

Meanwhile, the rear bogie 110 maneuvers to the rear of the trailer. Referring to FIG. 3B and FIG. 3C, the rear bogie 110 uses its onboard sensors to detect the rear tires 202 and axles, estimate the clearance below the axles and between the tires, and plan a path to position itself for engaging the lift point, as described above. Once at the rear, the rear bogie 110 engages a solid lift point (such as the axles, frame rails, tires, or other structural members) and lifts the rear of the trailer, as shown in FIG. 3C. The rear bogie 110 only begins lifting after the propulsion unit 140 has engaged with and lifted the front of the trailer.

In some lift mechanism embodiments, the rear bogie 110 coordinates longitudinal motion with lift mechanism engagement to avoid impacting yard infrastructure, such as loading docks or warehouse walls. In that case, the rear bogie 110 monitors its lift mechanism position relative to the engagement points (e.g., tires 202) and any nearby yard infrastructure while executing a driving path to maneuver into place.

In the wireless rear bogie embodiment picking up a trailer from trackside, the rear bogie 110 detects the trailer landing gear but may move underneath the trailer from the side, entering between the landing gear and rear tires, as described above.

Once the trailer is fully off of the ground, the trailer sled 100 can proceed to carry the trailer through the yard to its destination.

After picking up a trailer, the trailer sled 100 drives through the yard with the trailer toward a drop-off location. It obeys yard rules during transit, including rules regarding: staying under speed limits, following lane and route directionality, stopping at intersections, and respecting traffic precedence.

The trailer sled 100 transits the operating area with the same modeling, planning, and controls as in the unloaded case, except that planning and controls also account for the presence of the trailer. The trailer impacts the details of the planned path to ensure the trailer does not leave the expected travel corridor, accounting for the additional length and kinematic response of the combined trailer sled and trailer system.

Additional safety monitors are active during loaded transit. For example, the trailer sled 100 monitors whether the trailer drops off of the trailer sled via weight monitoring, throttle response analysis, and perception. The trailer sled 100 also detects potholes and other negative obstacles using perception and/or suspension sensors at the propulsion unit 140, then plans a path to avoid them so that the rear bogie’s smaller wheels are not caught in them. In some embodiments, the trailer sled 100 flags detected pavement anomalies to site personnel for repair.

Upon reaching a specified loading dock, the trailer sled 100 confirms that the dock is empty using onboard perception sensors, essentially the inverse of confirming the presence of a trailer prior to pick-up. Remote assistance may be requested to resolve any ambiguous results. If the dock is not empty, the trailer sled 100 alerts the customer dispatcher and waits for further instructions. The dispatcher (or an automated yard management optimization system) may redirect the trailer sled 100 to a new drop-off location or may redirect the trailer sled 100 to a waiting location until the dock is cleared.

Once the dock is clear, the trailer sled 100 confirms that the dock light for the loading dock is green (if present), indicating that it is safe to drop off the trailer. If the dock light is red, the trailer sled 100 waits for a green light. If no green light is detected within a configurable time period (e.g., 30 seconds), it alerts the customer dispatcher and waits for further instructions. The dispatcher can either have the trailer sled 100 continue to wait or instruct it to move to a new drop-off location. In some environments, no dock lights may be available, in which case this processing may not be performed.

Dock light status may be detected via multiple methods, including computer vision (e.g., color detection in captured images), a dedicated light sensor with narrow bandpass filters tuned to the red and green wavelengths of the dock lights, smart dock lights which transmit their status via radio-frequency (RF) signaling, centralized monitoring and status reporting via a yard management system or warehouse management system, or remote assistance.

Once the trailer sled 100 is clear to proceed with docking (for example, the loading dock light is green or in the absence of dock lights, the dock space is not occupied), the trailer sled 100 maneuvers the trailer 200 into the dock door, aligning the center of the trailer to the center of the loading dock. The novel form factor of the trailer sled 100 greatly simplifies alignment to loading docks by using sensors mounted at the rear of the rear bogie 110, enabling direct sensing of the loading dock from the rear of the trailer. Sensors may include LIDAR, monocular cameras, stereo cameras, structured light sensors, among others. Infrastructure aids may also be used, such as LIDAR reflectors or visual markers positioned at known locations relative to the dock centerline. Perception-mediated closed-loop control is then used to place the trailer at the dock centerline with minimal skew, ideally at a perfect 90 degrees relative to the dock face.

To further improve dock alignment, in some embodiments the rear bogie 110 includes a steering capability under load. Even a modest steering range (e.g., approximately 10 degrees) at the rear bogie 110 provides meaningful improvement in dock alignment precision, as it enables fine lateral adjustments of the trailer rear during the final approach to the dock.

The trailer sled 100 pushes the trailer all the way to the loading dock door until it engages with the dock bumpers on both sides of the loading dock. Engagement can be determined via multiple sensing modalities, including: perceiving the distance to the dock via the same sensors used for centering; observing a spike in the torque applied to the drive system coupled with a lack of motion; observing a spike in longitudinal acceleration indicating contact with the bumpers; or monitoring the precise position of the propulsion unit 140 in the yard while taking into account the length of the trailer as measured from the rear bogie perception system.

At that point, the trailer sled 100 lowers the rear of the trailer, retracts the rear bogie 110, and then lowers the front of the trailer. This is essentially the inverse of the pick-up process. The trailer sled 100 monitors when the trailer is fully lowered at the rear via perception (watching the tires contact the ground) or pressure/force monitoring of the lift mechanism (when the force measurement drops, the trailer rear is down). At that point, the rear bogie 110 collapses its lift mechanism and begins moving toward the front of the trailer. When lowering the rear at a loading dock, the rear bogie 110 may coordinate the collapsing motion with forward motion to avoid having the lift apparatus impact dock infrastructure. While moving toward the front, the rear bogie 110 uses sensor-based navigation to drive the bogie back to the front, avoiding tires and passing between the landing gear, in the same manner as used during the pick-up process (though the sensors may be different physical units pointed in the opposite direction). In the wireless rear bogie embodiment dropping off a trailer trackside, the bogie may exit the trailer from the side, between the tires and landing gear.

The propulsion unit 140 lowers the front once the rear is down, ensuring stability during the rear lowering process. The propulsion unit 140 and rear bogie 110 then mate together, either underneath the front of the trailer or immediately in front of it. Or in the case of trackside, in front of and to the side.

If at any point an obstacle is detected in the path of the trailer sled 100 or in the loading dock spot boundaries, the trailer sled 100 comes to a stop and waits for the obstacle to move out of the way. If the obstacle does not move after a predetermined length of time, the trailer sled 100 alerts the customer dispatcher for assistance. Finally, the trailer sled 100 drives out from under the trailer and proceeds to its next task. If no new task is available, the trailer sled 100 can wait in front of the trailer or proceed to a defined staging area.

Upon reaching a specified loading dock for trailer pickup, the trailer sled 100 confirms that a trailer is actually in the dock and that the correct trailer is in the dock. This process and technical approach is the same as at parking spots, as described above. After confirming the correct trailer is in the loading dock, the trailer sled 100 confirms that the dock light for the loading dock is green (if present, and using the same detection methods as for dropping a trailer at the loading dock), indicating that it is safe to retrieve the trailer. If the dock light is red, the trailer sled 100 waits for a green light. If no green light is detected within a configurable time period (e.g., 30 seconds), it alerts the customer dispatcher and waits for further instructions. The dispatcher can either have the trailer sled 100 continue to wait or instruct it to move to a new task.

Once the loading dock light is green, the trailer sled 100 aligns to the trailer and drives underneath the front in the same way as picking up from a parking spot. Once underneath the trailer, the trailer sled 100 securely engages with the trailer and lifts the front. Lifting can occur from any load bearing point, including the king pin, frame rails, or other structural members. Once the front is lifted, the powered rear bogie 110 is deployed to the rear of the trailer, where it engages a solid lift point (axles, frame rails, tires, etc.) and lifts the rear of the trailer. Once the trailer is fully off of the ground, the trailer sled 100 can proceed to carry the trailer through the yard to its destination.

If at any point during the loading process the dock light turns from green to red, the trailer sled 100 transitions to a safe state (fully stopped) and alerts the customer dispatcher. The trailer sled 100 does not continue movement until the dock light turns green again (possibly with a timeout).

Upon reaching a specified parking spot, the trailer sled 100 confirms that the spot is empty in the same way as it confirms an empty loading dock. If the spot is not empty, the trailer sled 100 alerts the customer dispatcher and waits for further instructions. The dispatcher (or yard management system) may redirect the trailer sled 100 to a new drop-off location, or may redirect the trailer sled 100 to a waiting location until the spot is cleared.

Once the spot is clear, the trailer sled 100 maneuvers the trailer into the parking spot, attempting to align the trailer both longitudinally and laterally within the spot boundaries. Longitudinal alignment is configurable per site, with options including: rear of trailer at rear of spot, front of trailer at front of spot, and center of trailer at center of spot. Lateral alignment prefers the center of the spot whenever possible, with deviations from the center line allowable if it optimizes the space between adjacent trailers. In no instance should the trailer be left outside of the parking spot boundaries.

Since parking spots do not have the same perceivable features as a loading dock, aligning the trailer in the spot uses a different approach. The trailer sled 100 uses a combination of parking spot markers (such as painted lines detected by computer vision) and yard position references (such as GPS coordinates, relative positions computed from the stored site model, or other coordinate frame references) to determine when the trailer is in the correct position for drop-off.

Once the trailer is in the correct position, the trailer sled 100 drops off the trailer in the same manner as dropping off at a loading dock, as described above. If at any point an obstacle is detected in the path of the trailer sled 100 or in the parking spot boundaries, the trailer sled 100 comes to a stop and waits for the obstacle to move out of the way. If the obstacle does not move after a predetermined length of time, the trailer sled 100 alerts the customer dispatcher for assistance. Finally, the trailer sled 100 drives out from under the trailer and proceeds to its next task. If no new task is available, the trailer sled 100 can wait in front of the trailer or proceed to a defined staging area.

When the trailer sled 100 is not needed for an extended period of time (configurable, but typically more than an hour), it moves to a predefined storage area 601 without a trailer. Once parked, it enters a low power mode and waits for operations to begin again. These waiting periods vary depending on site schedules. Some sites might not use waiting periods at all.

### Exception Handling and Remote Intervention

Pursuant to some embodiments, the trailer sled 100 provides the ability for a remote operator to intervene at each layer of the control architecture to aid system operation and recover from exceptions. Exceptions may include: stopping for an obstacle and being unable to automatically re-route around it; not locating the expected trailer for pickup; finding the destination spot already occupied; or detecting an internal error. The intervention methods depend on the architecture layer at which the remote operator is controlling.

Intervention at the task execution layer 440 involves modifying the world model to influence path plans, or directly adjusting path plans. An example would be marking an area of the yard as inaccessible (a no-go zone) or moving a planned route to traverse a different part of the yard.

Intervention at the safe navigation layer 430 involves modifying an individual path or granting permission to proceed when the trailer sled 100 is unable to determine if it is safe to do so. An example would be adjusting a path to move around an obstacle, or providing authority to proceed through a non-hazardous obstacle (such as a plastic bag, tumbleweed, or other debris that is not a safety threat).

Intervention at the safe controls layer 420 involves providing speed and steering requests directly to the trailer sled 100, while the trailer sled 100 enforces safety limits. This level of intervention is intended for line-of-sight operations when maneuvering the trailer sled 100 outside of its intended operating environment (such as during maintenance or transit between facilities) or recovering the trailer sled 100 from an error condition (such as when sensors or Task execution processors are malfunctioning).

Intervention at the core vehicle layer 410 is similar to the safe controls layer 420, except without the closed-loop controls or safety checks. This level of intervention is reserved for emergency use only.

Reference is now made to FIG. 8, where a process 800 that may be implemented by the control architecture 400 in communication with the propulsion unit 140 and rear bogie 110 is shown. The process 800 begins at 802 where the propulsion unit 140 is positioned proximate a trailer 200 to be maneuvered. At 804, the trailer 200 is engaged with the propulsion unit 140 (e.g., via engagement of the kingpin on the trailer with a fifth wheel or other connector of the propulsion unit 140). At 806, the rear bogie 110 is deployed to position the rear bogie 110 proximate the rear tires 202 of the trailer 200. At 808 the lift units of the rear bogie 110 are operated to place them in position proximate the rear tires 202 (e.g., such that the lift arms are extended and positioned in front of and behind the rear tires 202). While the process has been generally described as performing step 804 (engaging the trailer 200 with the propulsion unit 140) prior to step 806 (where the rear bogie 110 is deployed), the process may also include first deploying the rear bogie 110 and then engaging the trailer 200 with the propulsion unit 140 (that is, the processing may be swapped in sequence). For example, when the linkage mechanism 150 between the propulsion unit 140 and the rear bogie 110 is a mechanical linkage (as shown in FIG. 1A), the propulsion unit 140 may engage with the trailer 200 first. As another example, when the linkage mechanism 150 between the propulsion unit 140 and the rear bogie 110 is wireless, the rear bogie 110 may be deployed first (as both the rear bogie 110 and the propulsion unit 140 may move independently in such embodiments). At 810 the lift units of the rear bogie 110 are retracted or compressed (bringing them towards each other) to cause the rear tires 202 to be lifted off the ground and onto the lift arms. At this point, the propulsion unit 140 is supporting the front of the trailer 200 and the rear bogie 110 is supporting the rear of the trailer (through the rear tires 202) and processing can continue at 812 to control movement of the propulsion unit 140 and the rear bogie 110 to position and move the trailer 200 to a desired location.

The result is a trailer sled that is easy and inexpensive to operate and that can be used to move semi-truck trailers within a yard or other facility. The improved system of the invention can lift both the front and the rear of a trailer 200 using an under-trailer autonomous bogie and propulsion unit without requiring trailer modifications or pneumatic or electrical connections with the trailer. Embodiments improve yard safety by providing direct sensing of objects, including people, behind the trailer when backing. Embodiments avoid the need for a robotic arm or trailer modification (temporary or permanent) to enable connection of air and electrical lines. Embodiments are less expensive than other options as there is no need for onboard user interfaces (such as user controls, user seating, instrumentation, etc.).

Embodiments may be used with trailers of different sizes, and pursuant to some embodiments, the rear bogie 110 can directly sense the trailer length, making it easier to control backing and detect when the trailer is fully in a parking spot or docked. Sensors on the rear bogie 110 can directly sense the loading dock, making it easier to precisely position the trailer in the center of the dock door. Embodiments reduce or eliminate the need to leave a trailer on wheel dollies for the duration of the trailer’s time in the yard.

Embodiments provide improved localization of the trailer pose and improved situational awareness due to sensors on the rear bogie 110, and potentially enhanced mobility, which provides the opportunity to increase the density of docks and/or parking spaces, improving site and space utilization. Further, pursuant to some embodiments, the rear bogie 110 can directly sense the trailer weight, making it easier to balance trailer load for safe and compliant driving over the road. In the case of a wireless rear bogie, embodiments open the possibility of picking up trailers from the side for the rail yard trackside use case, as autonomous yard trucks cannot hitch at 90 degrees and still connect air and electrical lines.

Embodiments represent improvements over prior approaches for a number of reasons. For example, existing approaches do not lift the rear of the trailer, nor do they provide sensors at the rear of the trailer to eliminate blind spots while backing the trailer up. Embodiments allow automatic detection of when the rear tires are off the ground so the trailer sled can be moved. Further embodiments allow closed-loop perception-based docking control (sensing the dock location from the powered rear bogie and aligning based on that detection). Embodiments also allow the detection of an open dock door when backing the trailer and pausing the backing. Embodiments allow steering under load and steering from the rear bogie.

### Additional Embodiments

Those skilled in the relevant art(s) will appreciate that various adaptations and modifications of the embodiments described above can be configured without departing from the scope and spirit of the disclosure. Therefore, it is to be understood that, within the scope of the appended claims, the disclosure may be practiced other than as specifically described herein.

For example, in some embodiments, the front of the trailer may be picked up without using the kingpin. In some embodiments, the powered rear bogie 110 may be completely detached from the propulsion unit 140, operating wirelessly and then docking to recharge when there is no trailer onboard. In some embodiments, the rear bogie could lift at the axles, trailer frame, or the rear underride guard instead of lifting by the tires. In some embodiments, the propulsion unit 140 might connect to the kingpin from underneath instead of from the front. Further, in some embodiments the propulsion unit 140 might engage with the trailer frame instead of the kingpin. In some embodiments, the rear bogie 110 could maintain traction power and steering while a trailer is onboard, improving maneuverability. In some embodiments, the propulsion unit 140 could have four-wheel steering (controlling both axles). In some embodiments, the rear bogie 110 could allow for rear trailer wheels to be dragged onto a bogie platform.

In some embodiments, additional sensors may be provided to sense weight distribution between the front and rear of the trailer (e.g., to flag possible Department of Transportation violations), to sense lateral weight distribution to warn of a higher risk of rollover, to sense low tire pressure based on the deformation of tires when lifting, to inspect and assess the components that make up the trailer undercarriage (for example: frame, landing gear, axles, wheels, tires, and brake hardware), to sense or detect the presence of people or objects underneath the trailer or behind the wheels, and/or to provide audible or visual backup warning on the rear bogie 110 when backing up to a parking spot or dock.

We claim:

1. An automated trailer sled, comprising:
a propulsion unit comprising a moveable coupling mechanism configured to engage with a front of a semi-trailer and lift the front of the semi-trailer;
a rear bogie comprising at least a first lift unit and a second lift unit, each lift unit comprising a front arm and a rear arm;
a linkage mechanism coupling the propulsion unit to the rear bogie; and
wherein the rear bogie is configured to move to a position proximate a set of rear tires of the semi-trailer, position the front arm and the rear arm of each lift unit adjacent to the set of rear tires, and compress the front arm and the rear arm toward each other to engage with the set of rear tires and lift the set of rear tires;
wherein the propulsion unit is configured to move the semi-trailer with both a front and a rear of the semi-trailer lifted.

2. The automated trailer sled of claim 1, wherein the rear bogie comprises a central drive unit configured to cause movement of the rear bogie independently of the propulsion unit.

3. The automated trailer sled of claim 1, wherein the rear bogie is powered by the propulsion unit.

4. The automated trailer sled of claim 1, wherein each arm includes at least one roller configured to rotate to assist the set of rear tires onto the arm during the compression of the front arm and the rear arm.

5. The automated trailer sled of claim 4, wherein the at least one roller is a powered roller driven by at least one of (i) an electric motor, (ii) a hydraulic motor mounted within the arm, (iii) a gear train, and (iv) a belt and chain drive.

6. The automated trailer sled of claim 1, wherein each lift unit further comprises a vertical lift mechanism configured to raise the arm after the arm is positioned beneath the set of rear tires, wherein the vertical lift mechanism comprising a scissor-jack mechanism, wherein the scissor-jack mechanism is actuated by one or more of (i) a hydraulic piston, (ii) a pneumatic piston, and (iii) an electric motor.

7. The automated trailer sled of claim 1, wherein each arm comprises a pivot joint configured to allow the arm to rotate from a lowered position to a raised position, wherein as the rear tire rolls onto the arm, a weight of the tire causes the arm to pivot about the pivot joint to generate a vertical lifting force.

8. The automated trailer sled of claim 1, further comprising a wheel stop on a surface of the front arm and a surface of the rear arm, the wheel stop configured to prevent the set of rear tires from overshooting the surface of the front arm and the surface of the rear arm while the front arm and rear arm are compressed toward each other.

9. The automated trailer sled of claim 1, wherein the rear bogie has an overall height of approximately 12 inches or less.

10. The automated trailer sled of claim 1, further comprising one or more sensors on the rear bogie configured to sense a loading dock from underneath the semi-trailer, and a control system configured to use output of the one or more sensors to align the semi-trailer to the loading dock via closed-loop perception-based docking control.

11. The automated trailer sled of claim 10, wherein the rear bogie further comprises a steering mechanism operable under load to provide lateral adjustment of the rear of the semi-trailer during approach to the loading dock.

12. The automated trailer sled of claim 1, wherein the linkage mechanism comprises at least one of (i) a mechanical linkage, and (ii) a wireless linkage.

13. The automated trailer sled of claim 1, further comprising a control system implementing a layered control architecture comprising:
a core vehicle layer responsible for vehicle actuation;
a safe controls layer responsible for closed-loop speed and steering control with safety limits;
a safe navigation layer responsible for path following and obstacle avoidance; and
a task execution layer responsible for receiving task-level orders and generating execution plans including paths through a yard.

14. The automated trailer sled of claim 1, further comprising one or more sensors on the rear bogie configured to detect the set of rear tires and undercarriage components of the semi-trailer, and a control system configured to estimate a pose of the rear bogie relative to the set of rear tires using model fitting of sensor data to a prior model of undercarriage components.

15. A method of moving a semi-trailer within a yard, comprising:
positioning a propulsion unit of an automated trailer sled proximate a front of the semi-trailer;
engaging the front of the semi-trailer with the propulsion unit and lifting the front of the semi-trailer;
deploying a rear bogie from the propulsion unit to a position proximate a set of rear tires of the semi-trailer, the rear bogie traveling underneath the semi-trailer;
positioning at least one lift unit of the rear bogie adjacent to the set of rear tires, the at least one lift unit comprising a front arm and a rear arm;
compressing the front arm and the rear arm toward each other to engage with the set of rear tires and lift the rear tires; and
moving the semi-trailer within the yard with both the front and the rear of the semi-trailer lifted.

16. The method of claim 15, further comprising, prior to positioning the propulsion unit:
detecting a presence of the semi-trailer in a parking spot or loading dock using one or more sensors on the propulsion unit; and
confirming an identity of the semi-trailer by reading a trailer identification number using optical character recognition.

17. The method of claim 16, further comprising:
sensing a loading dock from one or more sensors on the rear bogie while the semi-trailer is being maneuvered toward the loading dock; and
aligning the semi-trailer to a centerline of the loading dock using closed-loop control based on the sensing.

18. The method of claim 17, wherein deploying the rear bogie comprises:
detecting a set of landing gear legs of the semi-trailer using sensors on the rear bogie;
estimating clearance between the set of landing gear legs;
navigating the rear bogie between the set of landing gear legs underneath the semi-trailer; and
detecting a set of rear tires and estimating a pose of the rear bogie relative to a rear undercarriage using model fitting of sensor data against a learned prior model of undercarriage components.

19. An automated trailer moving system, comprising:
an automated trailer sled comprising a propulsion unit and a rear bogie, the rear bogie configured to lift rear tires of a semi-trailer, the propulsion unit configured to lift a front of the semi-trailer and move the semi-trailer within a yard;
a control system distributed across the propulsion unit and the rear bogie, the control system implementing a layered architecture comprising a core vehicle layer, a safe controls layer, a safe navigation layer, and a task execution layer; and
a remote intervention interface configured to allow a remote operator to intervene at one or more layers of the layered architecture, wherein:
intervention at the task execution layer comprises modifying a world model or adjusting path plans;
intervention at the safe navigation layer comprises modifying an individual path or granting permission to proceed through a detected obstacle;
intervention at the safe controls layer comprises providing speed and steering requests directly while the control system enforces safety limits; and
intervention at the core vehicle layer comprises providing direct control commands without closed-loop safety checks.

20. The automated trailer moving system of claim 19, wherein the task execution layer is configured to:
receive task-level orders from a Yard Management System,
localize the trailer sled relative to a stored reference site model,
dynamically update a local model based on sensor inputs, and
plan vehicle trajectories leveraging yard rules, a road and lane network, and learned paths from prior task executions.
